(19) United States
(12) Patent Application Publication
(10) Pub. No.: US 2025/0222416 A1
(43) Pub. Date: Jul. 10, 2025

(54) AUGER PANELS WITH INTEGRATED GRILLES FOR IMMERSION TREATMENT DEVICES

(71) Applicant: Morris & Associates, Inc., Garner, NC (US)

(72) Inventors: Derek William Thompson, Knightdale, NC (US); David Howard Macaluso, Benson, NC (US)

(21) Appl. No.: 18/409,544

(22) Filed: Jan. 10, 2024

(51) Int. Cl. B01F 27/1144; B01F 101/06

(52) U.S. Cl. CPC B01F 27/1144; B01F 2101/06

(57) ABSTRACT

Disclosed are various embodiments an auger of an immersion treatment system. The auger can include auger panels that move a product and a treatment liquid in a treatment tank. A first auger panel can include at least: a leading edge and a trailing edge. The at least one of the leading edge and the trailing edge can include one or more gaps that form corresponding grille passages where the at least one of the leading edge and the trailing edge are connected to another auger panel at a weld joint.

### BACKGROUND

In many industrial processes including food preparation, products are treated by immersion in various treatment liquids. For instance, warm products can be chilled by immersion in cold water, cheese curd can be cured by immersion in brine, or food products can be immersed in an antimicrobial solution to reduce microbial contamination. Immersion treatment solutions can immerse a product as it travels through a treatment tank from one end to the other. An immersion treatment tank can include a trough-shaped half-round tank filled with a treatment solution. In some examples, an auger can rotate to encourage the product to move along the tank. The auger can provide positive movement in a desired direction. A solution such as water or other treatment solution can be introduced at one end of the tank and flows progressively to the other end opposite the direction of product flow. One of the problems of counter-flowing the treatment solution through the tank is that the auger, by its rotation as it moves the product forward, also pushes the treatment solution. The water must find its way around or through the auger in order to flow counter to the direction of the product or even simply to remain in place.

Some augers utilize solid auger flights so as to prevent the product becoming trapped or hanging against the auger and not moving properly through the tank, and to avoid damaging the product. Because of the desirability to employ augers with solid flights, the accepted way to move the water through the tank in a counter-flow direction with respect to both the auger and the product is to flow the water around the outside perimeter of the auger flights, between the auger and the facing surface of the tank, which is normally limited to a small dimension, such as between 1 inch and 1½ inches clearance space. This small space at the perimeter of the auger avoids having the smaller pieces of products becoming caught or trapped between the auger and the tank, and avoids damage to the product.

Since the counter-flow water movement that occurs in this arrangement flows only around the edges of the flights of the auger, and not uniformly through the mass of product at the centerline of the tank, there is a lack of uniformity and effectiveness in chilling the product that is at the centerline of the tank or that is “clumped” or clustered together in the tank. These designs can cause the product to migrate toward one sidewall of the tank because of frictional contact with the rotating auger, leaving the opposite side of the tank with less of the product, and the major circulation of water is about the edges of the auger flight that is free of birds and therefore open for water movement.

As a result, some augers can also include grilles that are separate components with respect to the auger panels, fitted and connected between adjacent panels in the auger flight. The grilles are joined to the panels by welding at the root and edges. This can result in a very difficult and arduous welding process, which can be both costly and time consuming. Furthermore, as indicated above, unlike solid flights, flights that include grilles between panels can cause product to get caught in the grilles.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 shows a perspective view of an auger constructed using auger panels with integrated grilles, as well as a perspective view of an immersion treatment tank, according to various embodiments of the present disclosure.

FIG. 2 is a zoomed-in perspective view of a portion of an auger constructed using auger panels with integrated grilles, according to various embodiments of the present disclosure.

FIG. 3 is a zoomed-in exploded view of two augur panels with integrated grilles, according to various embodiments of the present disclosure.

FIG. 4 is a drawing of various examples of joining edges of auger panels with integrated grilles, according to various embodiments of the present disclosure.

FIG. 5 is a side view of a portion of an auger constructed using auger panels with integrated grilles, according to various embodiments of the present disclosure.

### DETAILED DESCRIPTION

The present disclosure relates to auger panels with integrated grilles for immersion treatment devices. Industrial processes including food preparation can include treatment of products by immersion in various treatment liquids. For instance, warm products can be chilled by immersion in cold water, cheese curd can be cured by immersion in brine, or food products can be immersed in an antimicrobial solution to reduce microbial contamination. Immersion treatment solutions can immerse a product as it travels through an immersion treatment tank from one end to the other. An immersion treatment tank can include a trough-shaped half-round tank filled with a treatment solution. Some auger-based treatment devices can utilize solid auger flights so as to prevent the product becoming trapped or hanging against the auger and not moving properly through the tank, and to avoid damaging the product.

The counter-flow water movement that occurs in solid-auger arrangement flows only around the edges of the flights of the auger, and not uniformly through the mass of product. Some augers can also include grilles as separate components with respect to the auger panels, fitted and connected between adjacent panels in the auger flight. This type of auger grille is joined to the panels by welding at the root and both edges with a full weld line on each side of the grille, one for each adjacent auger panel. This can result in a very difficult and arduous welding process, which can be both costly and time consuming. Furthermore, as indicated above, unlike solid flights, flights that include grilles between panels can cause product to get caught in the grilles. For treatment processes related to food processing, welded joints should be fully sealed so that no crevices remain that might harbor pathogens. Sanitation considerations indicate that the welds be continuous, for example, skip welding can leave crevices that can harbor pathogens. Adjacent items around the shaft must be seal welded on both sides of their adjoining edges for the full length of the joint from the root end adjacent the central shaft to the outer edge of the helical blade. This amount of welding is relatively expensive and can lead to distortion of the base metal due to the amount of heat involved.

However, the present disclosure describes systems, devices, and methods that can reduce the welding length compared to panel and grille configurations for current devices. For example, present disclosure can reduce the length of weld needed to join adjacent panels at least by integrating the liquid passages of the grille as part of a panel, and placing at least some of the liquid passages of the grille such that the passages span across the adjoining edges to be joined. The extent to which the length of the joined edges is interrupted by open passages can reduce the length of welding to something less than the full distance from the root of the panel to the outer edge of the helix. Accordingly, a panel of a particular radial dimension from a center shaft can include a reduced weld length relative to traditional devices with the same or similar radial dimension. In some examples, the joined edges do not form a straight line. The present disclosure can also utilize bends or folds in the panel that can prevent or reduce trapping product on the grilles while maintaining rigidity and strength of the panel.

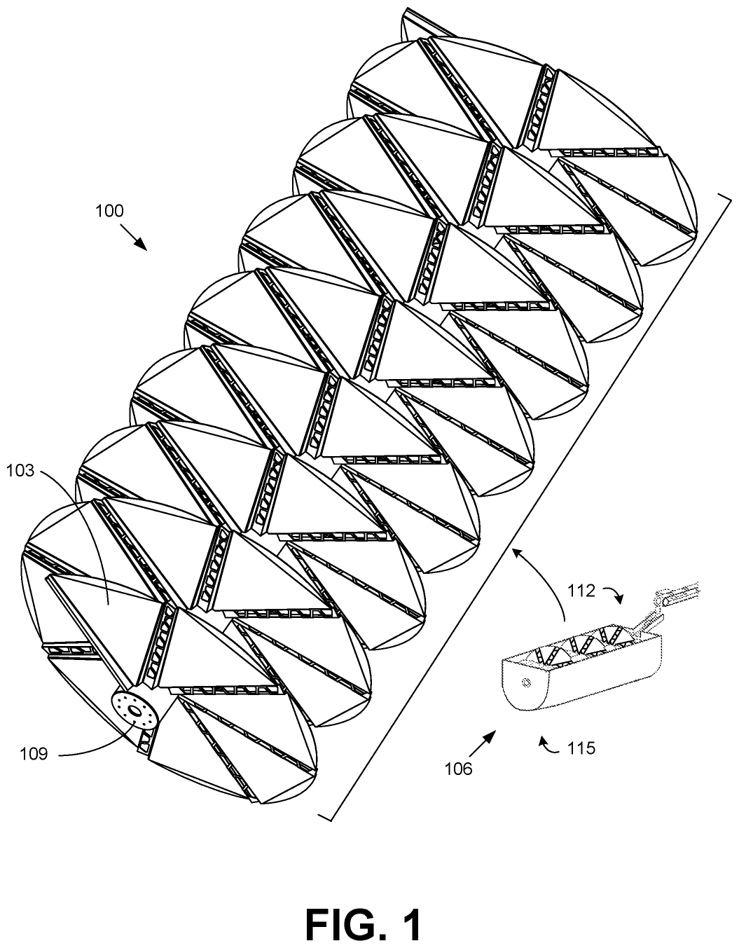

FIG. 1 shows a perspective view of an auger 100 constructed using a number of auger panels 103 with integrated grilles. The figure also shows an immersion treatment tank 106. The auger 100 can be a component of the immersion treatment tank 106.

The auger 100 can refer to an Archimedes screw or other type of screw of an immersion treatment tank 106. The auger 100 can be fabricated by attaching precisely formed auger panels 103 around a central shaft 109 to form a helical blade or auger flight. The central shaft 109 can include a cylindrical shape, and can be physically supported by connections to opposing ends of the immersion treatment tank 106.

Each of the auger panels 103 can include an integrated grille that can reduce the welding length used to connect two panels 103. The welding length reduction can be relative to the total radial distance from the center (and/or circumferential outer edge) of the central shaft 109 to the outer circumferential edge of the auger panel 103. By contrast, existing devices ca weld the entire radial distance, and can use a separate grille, thereby using two welds. As a result, the auger panels 103 can provide a significant reduction in welding length. This reduction can increase the speed and efficiency of construction, as well as reduce the amount of welding filler used. An auger panel 103 can be made by bending, cutting, stamping, and otherwise forming a single piece of sheet metal or plate metal.

An immersion treatment system can include the immersion treatment tank 106 having a chamber. The chamber has an inlet end 112 and a discharge end 115. The auger 100 can advance the product from the inlet end 112 to the discharge end 115. Multiple chambers and immersion treatment tanks 106 can be used in other embodiments, for example, to accommodate a second conveyor advancing the product through a different solution.

Immersion treatment tanks 106 come in a variety of configurations. Immersion treatment tanks 106 in a continuous treatment process can be configured to hold treatment liquid and to receive product at the inlet end 112 and unload product at the discharge end 115. The immersion treatment system can include provisions to add treatment liquid to the immersion treatment tank 106 such as a treatment liquid supply line, and liquid lines to drain liquid from the immersion treatment tank 106, as well as controls such as automatic valves, weirs, and other components to maintain a liquid level in the immersion treatment tank 106. The immersion treatment system can be designed so that the product moves sequentially through it such that the first unit of product introduced into the treatment system is approximately the first piece to be taken out (FIFO). The motion of the auger 100 can be controlled in order to control the residence time of the product in the immersion treatment tank 106.

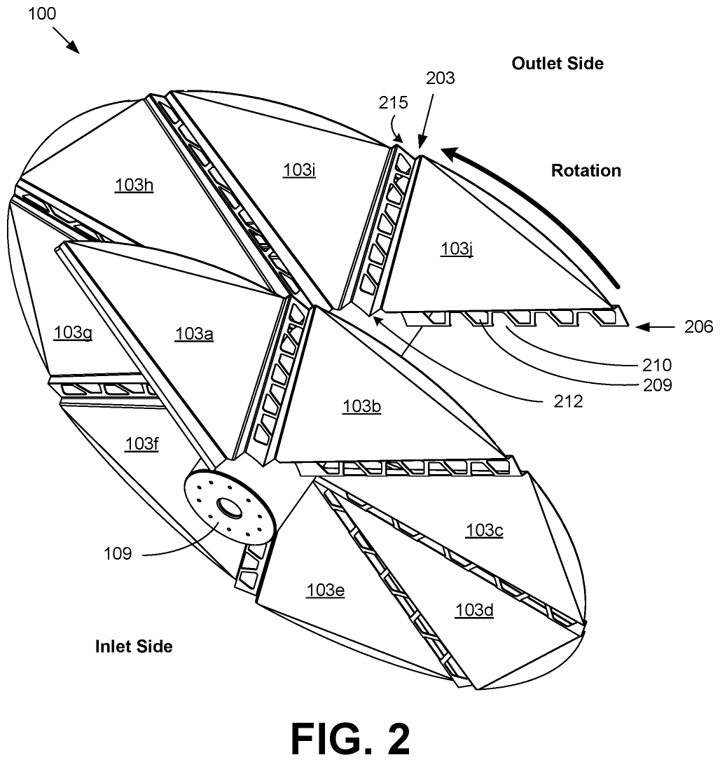

Moving to FIG. 2, shown is a zoomed-in perspective view of a portion of the auger 100. The zoomed view shows that the auger 100 is constructed using auger panels 103 around a central shaft 109. The auger panels 103 can include at least the auger panels 103a-103j. The auger panels 103a-103h can provide a first full (e.g., ≥360°) revolution of the auger flight of the auger 100. The auger panels 103i-103j can be part of a second revolution of the auger flight of the auger 100. The auger 100 can provide any number of auger panels 103 to make a full revolution around its central shaft 109. The auger 100 can provide any number of revolutions of joined panels 103 about its central shaft 109.

Each of the auger panels 103 can include two joining edges that are joined with other ones of the auger panels 103. The joining edges can be referred to as leading edges and trailing edges, or another terminology can be used. A leading edge can refer to the edge that “leads” rotation as a furthest radial edge in the direction of rotation, while a trailing edge can trail rotation as a furthest radial edge the direction opposite of rotation. For example, the auger panel 103j can have joining edges including a leading edge 203 and a trailing edge 206.

In this view, the trailing edge 206 of auger panel 103j can be seen to incorporate at least a portion of a set of grille passages 209. The subset or portion of the grille passages 209 are incorporated into the trailing edge 206 as open gaps 210, that become enclosed once welded or otherwise affixed to a leading edge of the next auger panel 103. The auger panel 103j also include another portion or subset of the grille passages 209 that are enclosed in the auger panel 103j. In the example shown, the leading edges are straight and do not include gaps 210 increase the flow area of grille passages 209, however, in other examples, the leading edge of the auger panels could have gaps 210 that match those of the trailing edge, and thus enlarge the grille passages 209. In general, gaps 210 in a leading or trailing edge occur where concavity in the edge profile prevents adjoining edges of adjacent panels 103 from touching when the panels are mated together leaving a grille passage 209 through which liquid may flow.

While the grille passages 209 are shown with alternating-direction trapezoidal shapes, any type and arrangement of shapes can be used, which can include any polygonal (n-gonal with n edges) shape, any curved, shape, and any bespoke shape. An auger panel 103 can have any number of grille passages 209 and the passages can be any size. The grille passages 209 can be sized such that a target product such as a whole bird or a wing in the case of poultry products, or another product cannot pass through the grille passages 209. For example, the grille passages 209 can have a largest dimension that is smaller than a smallest dimension of the targeted product. The corners of the grille passages 209, including the corners where joined at weld joint to create a corner, can be rounded to prevent catching up on a product being chilled or otherwise treated in the treatment tank. A most-acute corner angle of a grille passage 209 can be wide enough such that known catching points of the product, such as a wingtip, a knuckle of a drumstick, or another particular catching point has a reduced chance of being wedged in the most-acute corner.

The grille passages 209 of the trailing edge 206 can reduce the welding length needed to join a leading edge of a next adjacent auger panel 103, after the auger panel 103j. The grille passages 209 can also be referred to as liquid passages or treatment solution passages. This can reduce the length of welding to a distance that is less than a full distance from a root 212 of the auger panel 103j at the central shaft 109, to the circumferential outer edge 215 of the auger panel 103j along the welding line. Accordingly, a panel having a particular length measured radially from a central shaft 109 to the circumferential outer edge 215 of the auger panel 103j along the welding line can include a reduced weld length relative to traditional devices with the same or similar radial dimension.

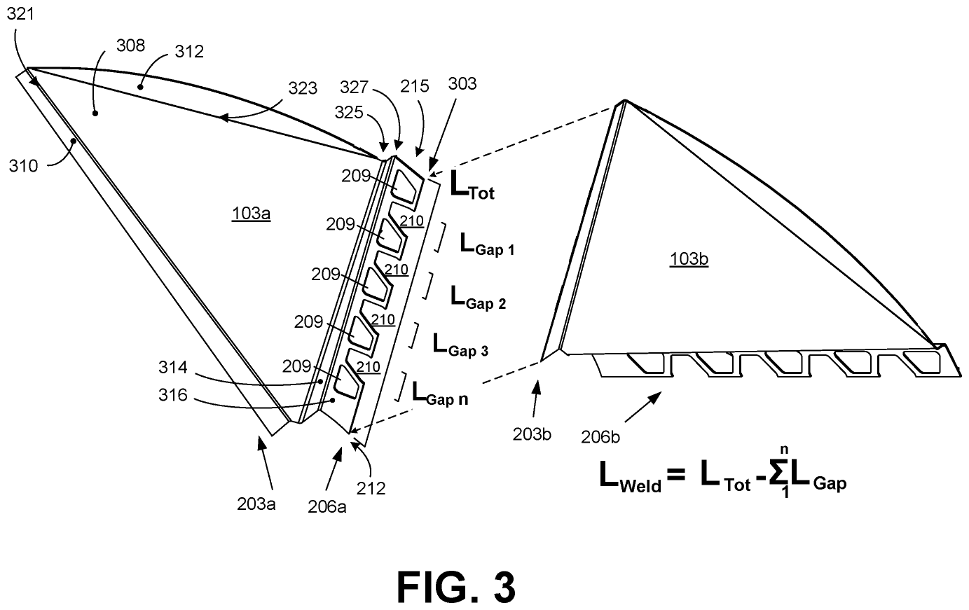

FIG. 3 is a zoomed-in exploded view of two augur panels 103, including augur panels 103a and 103b. The augur panels 103 can be made of sheet metal, plate, or another rigid sheetlike material. At least one of the joining edges of each augur panel 103 can incorporate grille passages 209 that enable liquid to pass through the auger 100 in a direction opposite of product flow.

The joining edges of the auger panel 103a can include a leading edge 203a and a trailing edge 206a. The joining edges of the auger panel 103b can include a leading edge 203b and a trailing edge 206b. The trailing edge 206a of the auger panel 103a can be welded to the leading edge 203b of the auger panel 103b. At least one of the trailing edge 206a of the auger panel 103a and the leading edge 203b of the auger panel 103b can incorporate gaps 210 that will define at least a portion of a set of grille passages 209 once the edges are joined. As shown, the trailing edge 206a of the auger panel 103a incorporates a set of grille passages 209 corresponding to gaps 210 of length L_{Gap1}, L_{Gap2}, L_{Gap3}, and L_{Gapn}, which reduce a weld length L_{Weld} such that L_{Weld} corresponds to equation 1.

$${L}_{Weld} = {L}_{Tot} - {\sum }_{1}^{n} Lgap n$$

In other words, the total weld length L_{Weld} can be reduced from the total edge length L_{Tot} by the various gap 210 lengths L_{Gap1}, L_{Gap2}, L_{Gap3}, and L_{Gapn}. The total length L_{Tot} can be measured radially from the root 212 at the center connection point, to the circumferential edge 215 of the auger panel 103a, along a weld joint 303. While a certain number of gaps 210 are shown, the number of gaps 210 can vary in other embodiments. While the gaps 210 are shown to have a same or similar length in this example, the gaps 210 can have different lengths, shapes, and sizes in other embodiments.

While referred to as a single joint, the weld joint 303 can include a number of separate joined portions which can alternatively be considered separate “joints.” In this example, the trailing edge 206a of the auger panel 103a can form an angle with the leading edge 203b of the auger panel 103b at the welding point once connected. This can form a corner joint of any angle, such as 90 degrees or any other angle. Providing the corner joint between the trailing edge 206a of the auger panel 103a and the leading edge 203b of the auger panel 103b can reduce a total number of bends required to produce the auger 100, while also reducing welding length by the gaps 210 along the welding joint. In other examples, the trailing edge 206a of the auger panel 103a can form a plane at a “butt” weld joint 303 with the leading edge 203b of the auger panel 103b once connected. Other types of weld joints 303 can also be used. Trailing edge 206a can be connected to a next panel of the auger flight.

For treatment processes related to food processing, weld joints 303 can be fully sealed so that no crevices remain that might harbor pathogens. Sanitation considerations indicate that the weld joints 303 be continuous such that touching or joined portions of two adjacent auger panels 103 are welded continuously along the joined portion. Skip welding can leave crevices that can harbor pathogens. Adjacent auger panels 103 (and other items) around the central shaft must be seal welded on both sides of their adjoining edges. This type of welding can also cause warping, so the described structures can help prevent or reduce warping.

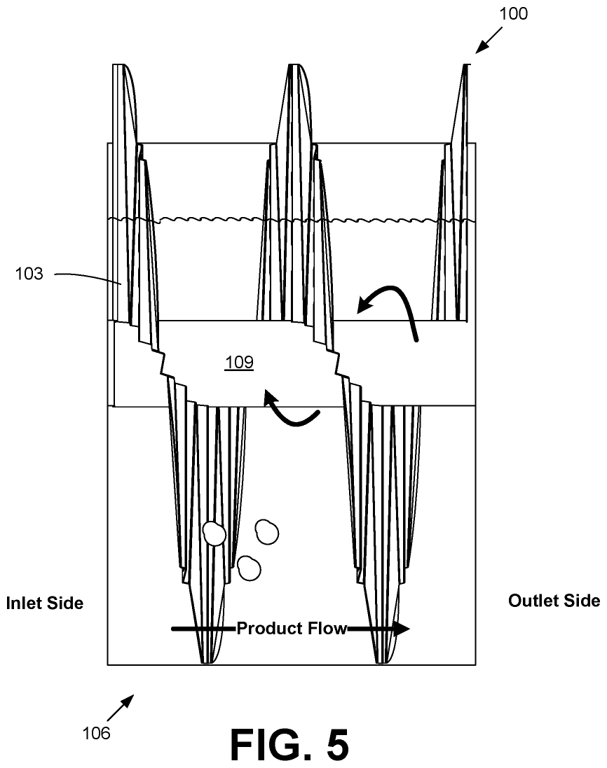

The present disclosure can also utilize bends or folds in the auger panels 103 that can maintain rigidity and strength of the auger panels 103. The folds can also help to obscure the grille passages 209 such that food product impacts with the grille passages 209 are reduced during rotation of the auger 100. This is described in further detail with respect to FIG. 5.

One example set of bends or folds in the auger panels 103 can be described with respect to auger panel 103a. The auger panel 103a can include a central or main panel 308 that is substantially planar or flat material such as sheet metal or plate metal. The auger panel 103a can include a leading edge tab 310, a circumferential edge tab 312, a trailing edge and/or grille passage offset section 314 and a trailing edge tab 316.

The leading edge tab 310 can form the leading edge 203a of the auger panel 103a. The leading edge tab 310 can bend from the main panel 308 at a bend line 321, forming a first predetermined angle. The circumferential edge tab 312 can bend from the main panel 308 at a bend line 323, forming a second predetermined angle. The offset section 314 can bend from the main panel 308 at a bend line 325, forming a third predetermined angle. The trailing edge tab 316 can bend from the offset section 314 at a bend line 327 forming a fourth predetermined angle. Other bends can be provided in other examples of the auger panel 103a. However, in this embodiment, the bend lines 321, 323, and 325 allow nominally flat auger panels 103 to approximate a continuously curved helical blade about the auger shaft 109 and also provide rigidity to the auger 100 and auger panel 103a. The set of bend lines 325 and 327 can enable the trailing edge tab 316 to face in a direction such that when the auger rotates the trailing edge tab applies less pressure to the product than does the central panel 308 thereby reducing the likelihood that product will clog the grille passages 209. For example, the trailing edge tab 316 may intersect a plane normal to the axis of the central shaft 109 along a line substantially radial to the axis to form an angle between 0-20 degrees such that the leading edge of the tab at bend 327 is closer to the discharge end 115 of the auger 100 than is the trailing edge of the tab 206a. In contrast, the central panel 308 makes an angel with such a normal plane whereby the leading edge of the panel at bend 321 is farther from the discharge end 115 of the auger 100 than is the trailing edge of the panel at bend 325.

The bend lines 321, 323, and 325 can form a substantially triangular set of bends around the main panel 308. In this context, substantially triangular can indicate that in an instance in which a respective one of the set of straight bends is extended, a triangle is formed, even if the bend lines do not perfectly meet on the main panel 308 itself. The bend lines 321, 323, and 325 can provide axial rigidity and strength, for example, parallel to the axis formed by the central shaft 109. The bend lines 321, 323, and 325 can prevent bending of the main panel 308 as well as the tabs and other sections of the auger panel 103a.

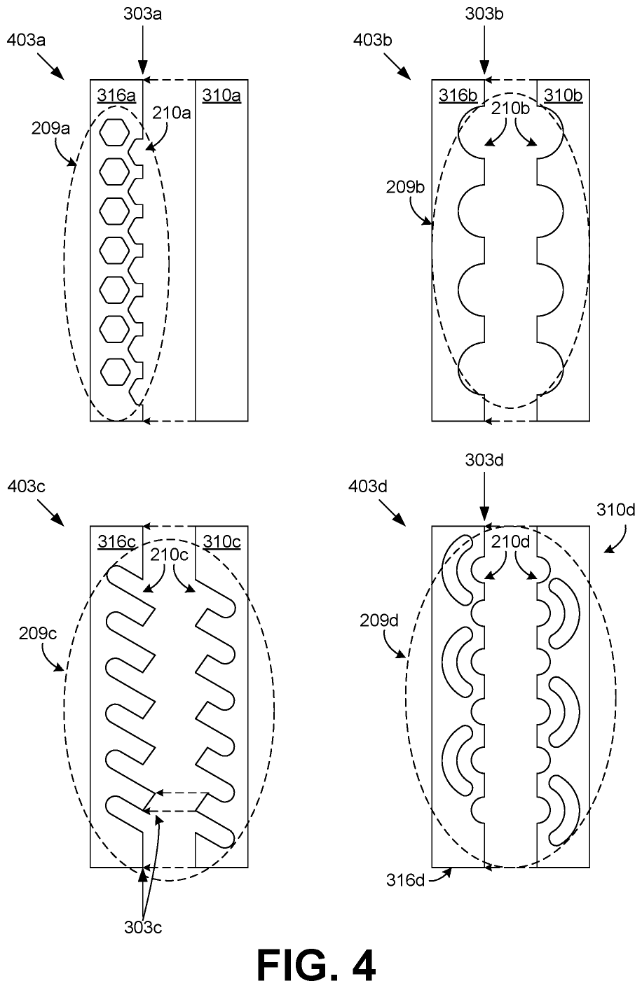

FIG. 4 is a drawing of examples of joining edge sets 403a-403d of auger panels 103 of the other figures. Each of the joining edge sets 403 can refer to a trailing edge of one auger panel 103, and a leading edge of another auger panel 103, which can be joined by one or more weld joint 303. The various joining edge sets 403a-403d are provided as nonlimiting examples that can be illustrative of many more designs and shapes for joining edges for auger panels 103. While the joining edge sets 403a-403d are shown adjacent to each other as if they join at a butt joint, they can also join to form any weld joint such as a corner joint, lap joint, or any kind of joint.

The joining edge set 403a can include the trailing edge 316a and the leading edge 310a, which can be joined at a weld joint 303a. The weld joint 303a can be considered a set of weld joints 303a that join the trailing edge 316a and the leading edge 310a. The trailing edge 316a can include a set of grille passages 209a. A subset of the grille passages 209a can be fully enclosed in the trailing edge 316a. Another subset of the grille passages 209a can include gaps 210a in the trailing edge 316a, which can define a second subset of the grille passages 209a when set of one or more weld joints 303a join the trailing edge 316a to the leading edge 310a. In this example, the leading edge 310a can be continuous or substantially straight, and lacks or omits gaps 210 for grille passages 209a. As a result, the second subset of the grille passages 209a defined by joining the two panels are a different shape than those fully enclosed in the trailing edge tab. The leading edge 310a can bridge the gaps 210 in trailing edge 316a and thus encloses and defines the subset of the grille passages 209a along the weld joint 303a.

The joining edge set 403b can include the trailing edge 316b and the leading edge 310b, which can be joined at a weld joint 303b. The weld joint 303b can be considered a set of weld joints 303b that join the trailing edge 316b and the leading edge 310b. The trailing edge 316b and the leading edge 310b can be joined at the weld joint 303b to form a set of grille passages 209b. In this example, all of the grille passages 209b correspond to matching gaps 210b in the trailing edge 316b and the leading edge 310b. While the joining edge set 403a and the examples shown in other figures include rounded-corner polygonal (trapezoidal) grille passages 209, the grille passages 209b of the trailing edge 316b and the leading edge 310b can be round or semicircular. In this example, the trailing edge 316b and the leading edge 310b are symmetrical with respect to one another with a mirrored symmetry. The joining edge set 403b omits enclosed grille passages 209b in either one of the trailing edge 316b and the leading edge 310b when separate and unconnected from one another.

The joining edge set 403c can include the trailing edge 316c and the leading edge 310c, which can be joined at a weld joint 303c. The weld joint 303c can be considered a set of weld joints 303c that join the trailing edge 316c and the leading edge 310c. All of the grille passages 209c in the trailing edge 316c correspond to aligning gaps 210c of the leading edge 310c such that they are asymmetrical but aligned. The segments of the trailing edge 316c and the leading edge 310c which are to be welded do not fall along a straight line. While this example can show a butt weld example, additional bends can be made in the trailing edge 316c and the leading edge 310c such that a set of weld joints that do not fall along a straight line can form a set of corner joints. The joining edge set 403c omits enclosed grille passages 209c in either one of the trailing edge 316c and the leading edge 310c when separate and unconnected from one another. However, in this example, the trailing edge 316c and the leading edge 310c are asymmetrical. The grille passages 209c, once formed by connecting the trailing edge 316c and the leading edge 310c at the weld joint 303c, can include straight-sided, rounded-end slots set at a predetermined angle from the weld joint 303c.

The joining edge set 403d can include the trailing edge 316d and the leading edge 310d, which can be joined at a weld joint 303d. The weld joint 303d can be considered a set of weld joints 303d that join the trailing edge 316d and the leading edge 310d. The joining edge set 403d can include a subset of grille passages 209d in each of the trailing edge 316d tab and the leading edge 310d tab, which are enclosed when separate and unconnected from one another. The grille passages 209d can also include passages that are open gaps 210d until joined at the weld joint 303d. The trailing edge 316d and the leading edge 310d can be asymmetrical.

The various joining edge sets 403a-403d can include grille passages 209 that are symmetrical or asymmetrical, and can be included in one or more of the trailing edge tabs 316 and the leading edge tabs 310. However, in each example, the welding length of the respective weld joint 303 can be shorter than a full length of the weld joint 303.

FIG. 5 is a side view of a portion of a chiller or immersion treatment tank 106 that includes an auger 100 constructed using auger panels 103 with integrated grilles. This figures shows how rotation of the auger 100 about an axis of the central shaft 109 can cause a product to flow across the immersion treatment tank 106. The grilles of the auger panels 103 can be designed to be fully obscured, mostly obscured, or substantially obscured beyond a threshold percentage from the side view. For example, substantially obscured in this context can refer to a maximum viewable area from any angle of rotation from a side view being obscured by 85%, 90%, 95%, or another threshold percentage relative to total area of the set of grilles 209 of a particular panel.

Multiple immersion treatment systems may be linked in series, for example to apply successive treatments of different treatment liquids. Embodiments with multiple systems can include sequential operations where the product exiting from an output point of an immersion treatment system including an immersion treatment tank 106 is input into an input point of another immersion treatment system, which can have the same or a different treatment liquid. The product can be disposed to sink, float, or be neutrally buoyant in the treatment liquid depending on the relative mass densities (or specific gravity) of the product and the treatment liquid. This can cause the product-to-liquid ratio to vary naturally at various depths within the treatment liquid.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, the following is claimed:

1. An immersion treatment system for treating a product by immersion in a treatment liquid, the immersion treatment system comprising:
a treatment tank for holding the treatment liquid for treating the product; and
an auger comprising a plurality of auger panels for moving the product and the treatment liquid, a first auger panel of the plurality of auger panels comprising:
a main panel section,
a leading edge, and
a trailing edge, wherein at least one of the leading edge and the trailing edge comprises at least one gap, and wherein at least one grille passage is defined at least in part by the at least one gap where the at least one of the leading edge and the trailing edge is joined to a second auger panel of the plurality of auger panels using at least one weld joint.

2. The immersion treatment system of claim 1, wherein the leading edge corresponds to a radial edge that leads in a direction of rotation.

3. The immersion treatment system of claim 1, wherein the trailing edge corresponds to a radial edge that leads in a direction opposite of rotation.

4. The immersion treatment system of claim 1, wherein the first auger panel is built from a single piece of sheet metal or plate metal.

5. The immersion treatment system of claim 1, wherein the first auger panel further comprises a circumferential edge tab that extends from a bend in the main panel section to a circumferential edge.

6. The immersion treatment system of claim 1, wherein the first auger panel comprises a plurality of bends that form a substantially triangular shape that provides axial rigidity.

7. The immersion treatment system of claim 1, wherein the at least one weld joint comprises at least one corner joint.

8. A method, comprising:
forming an auger comprising a plurality of auger panels for moving a product and a treatment liquid in a treatment tank; and
forming a first auger panel of the plurality of auger panels, the first auger panel comprising at least: a leading edge and a trailing edge, wherein at least one of the leading edge and the trailing edge comprises at least one gap, and wherein at least one grille passage is defined at least in part by the at least one gap where the at least one of the leading edge and the trailing edge is joined to a second auger panel of the plurality of auger panels using at least one weld joint.

9. The method of claim 8, wherein the plurality of auger panels are connected to a central shaft.

10. The method of claim 8, wherein the auger comprises an Archimedes screw.

11. The method of claim 8, wherein the first auger panel is built from a single piece of sheet metal or plate metal.

12. The method of claim 8, wherein the first auger panel is built from a single piece of sheet metal or plate metal.

13. The method of claim 8, wherein the first auger panel comprises a plurality of bends that form a substantially triangular shape that provides axial rigidity.

14. The method of claim 8, wherein the weld joint comprises a corner joint.

15. An auger for an immersion treatment system, the auger comprising:
a plurality of auger panels for moving a product and a treatment liquid in a treatment tank; and
a first auger panel of the plurality of auger panels, the first auger panel comprising at least: a leading edge and a trailing edge, wherein at least one of the leading edge and the trailing edge comprises at least one gap, and wherein at least one grille passage is defined at least in part by the at least one gap where the at least one of the leading edge and the trailing edge is joined to a second auger panel of the plurality of auger panels using at least one weld joint.

16. The auger of claim 15, wherein the plurality of auger panels are connected to a central shaft.

17. The auger of claim 15, wherein the first auger panel is built from a single piece of sheet metal or plate metal.

18. The auger of claim 15, wherein the first auger panel is built from a single piece of sheet metal or plate metal.

19. The auger of claim 15, wherein the first auger panel comprises a plurality of bends that provide axial rigidity.

20. The auger of claim 15, wherein the weld joint comprises a corner joint.
